(19) United States
(12) Patent Application Publication
(10) Pub. No.: US 2007/0107287 A1
(43) Pub. Date: May 17, 2007

(54) INFORMATION DISPLAY FOLDER

(76) Inventor: Chun-chieh Huang, Auburn, WA (US)

Correspondence Address: AXIOS LAW GROUP, 1725 WESTLAKE AVENUE NORTH, SUITE 150, SEATTLE, WA, 98109, US

(21) Appl. No.: 11/462,684

(22) Filed: Aug. 4, 2006

Related U.S. Application Data
(60) Provisional application No. 60/597,144, filed on Nov. 13, 2005.

(51) Int. Cl. G09F 7/00

(52) U.S. Cl. 40/611.1

(57) ABSTRACT

An information display folder is provided herein.

### RELATED INVENTIONS

This application claims the benefit of U.S. Provisional Application No. 60/597144, entitled CAR WINDOW POCKET, filed on Nov. 13, 2005, hereby incorporated by reference.

### FIELD

The present invention relates generally to displaying information and more particularly to an information display folder for the display and distribution of information from an automobile or suitable window.

### BACKGROUND

An enormous amount of money is spent annually on distributing information, whether it is for the purposes of advertisement, announcement, promotion, public information or to simply inform. An important aspect of any form of distribution is the ability to provide the information to the target audience. This is often accomplished by making the information available in the region or area the audience is most likely to be or by presenting the information directly to the target audience if the location of the identified audience is known.

Distributing to the general population, for instance, by passing out flyers, is often costly and ineffective as the information is most often distributed to uninterested parties even if the targeted population is localized. Similarly, when information is left at identified locations, for instance, on a local bulletin board or at a local cafe, only a small amount of the information reaches the target audience at any one location. Since the location is fixed, the location is often chosen based upon the number of people that are likely to see the information or at least pass by the information. Multiple locations must therefore be populated with the information in order to reach even a small amount of potential purchasers. While distributing to a target audience is much more effective, it is often costly as the process of identifying the target audience regularly involves extensive marketing and research.

Advertising is the most common reason for the distribution of information. There are many different ways for individuals and businesses to advertise items for sale. For instance, numerous types of classifieds exist in the market today. These include printed classifieds in periodicals and newspapers and on-line classifieds such as Craigslist® of San Francisco, Calif. Other methods of advertising items for sale include EBay® of San Jose, Calif. and the posting of printed material at local establishments and bulletin boards. Each of these methods involve posting the information at a fixed location, be it in a particular newspaper, at a particular website or on a particular bulletin board. The audience for each of these methods is limited to those individuals who read or subscribe to the periodical, those who visit the particular website and those that frequent the local establishment or bulletin board. Again, while direct marketing is available, given the cost, this method is almost always cost prohibitive for the sale of a personal or small valued items.

The advertisement of new and used automobiles represents a large portion of both on-line and print advertising. While the distribution of information for the purposes of selling an automobile present unique problems, it is also exemplary of the problems inherent in the distribution of most forms of information and advertising in general. For the new car industry, advertising is primarily done through television commercials and printed advertisements in both magazines and newspapers. Although automotive dealers that sell used cars also utilize television and print advertisements, most used cars are sold by individuals through classified ads, online advertisements, trade publications or direct advertisement on the automobile itself.

Hundreds of different types of automobiles exist on the market today. Automobiles are designed for a variety of uses both general and specific. Customers likewise purchase automobiles for their ability to fulfill particular utilitarian needs or to satisfy the purchaser's aesthetic desires. The qualities and capabilities of a particular automobile are therefore an important aspect of the potential buyers purchasing decision. While basic information such as make, model, year and color may be ascertained through a photo or simply by viewing the car itself, the majority of information about a car can usually be obtained through a detailed description of the cars history and specifications.

The current forms of advertising automobiles limit the seller's ability to provide critical information to the buyer both in terms of cost and available advertising space. Lengthy ads that contain photos and detailed information are costly and many newspapers and trade publications limit the space or number of words that can be used in a classified ad. On-line sales companies such as EBay® of San Jose, Calif., offer the seller the ability to post numerous photos as well as lengthy descriptions of the advertised automobile. Yet, most people that purchase used cars will not make an offer or finalize a sale unless they are given the opportunity to view the car. While photos are certainly helpful to the purchasing decision, they can be easily doctored or taken in ways that hide particular qualities of an automobile. A visual inspection of the car is often important to the sale of a used car even if a detailed description is available.

A common method for advertising a used car is to post a “For Sale” sign in the window of the vehicle. Such signs are often used even when the seller has advertised the car both on-line and in print ads. The “For Sale” sign will usually contain basic information about the car such as make, model, mileage and price. The main purpose of the For Sale sign is to provide a method by which the buyer can contact the seller in order to obtain more information about the vehicle. Often times, this contact information consists of a phone number, email address or website.

For Sale signs are often small thereby limiting the amount of information that can be presented upon them. They are meant primarily to grab the attention of the passerby, whether they are on foot or driving by the vehicle. Unfortunately, if the potential buyer is driving by the vehicle, they have a limited amount of time in which to read the For Sale sign and obtain the necessary contact information. This is especially true if the automobile is located on a busy or congested roadway. Even if the buyer happens to be walking or biking by the automobile and has time to stop and inspect the car, they must still have the ability to copy down the provided information or remember it long enough to transcribe it at a later time. Sellers therefore often do not include detailed information on the For Sale sign, even if space is available, as the information must be repeated to the buyer anyway.

In order to prevent the sign from being stolen, altered or destroyed by individuals or weather conditions, the For Sale sign is often attached to the inside window of the vehicle using a semi-permanent method such as tape or glue. Such semi-permanent methods of attaching the sign to the car make it inconvenient for the driver to take the sign down each time the vehicle is used. As such, the sign is often left in place while the owner is operating the vehicle thereby creating a driving hazard for the cars operator. Depending upon the position and size of the sign, dangerous blind spots can be created that limit the driver's ability to see other vehicles, pedestrians or other driving hazards. While attaching the sign to the outside of the vehicle may force the driver to remove the sign when the car is in use, the sign is then vulnerable to being removed by vandals or destroyed by wind or weather.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

### BRIEF DESCRIPTION OF THE DRAWINGS

FIG. 1 is a perspective view of an embodiment of an information display folder as it is secured to an automobile.

FIG. 2 is a cut away view of an embodiment of an information display folder.

FIG. 3 is a front view of an embodiment of an information display folder with sign and information enclosed therein.

FIG. 4 is a front view of an embodiment of an information display folder internal pocket exposed and with sign and information enclosed therein.

FIG. 5 is a front view of an alternate embodiment of an information display folder.

FIG. 6 is a front view of an alternate embodiment of an information display folder.

### DETAILED DESCRIPTION

In various embodiments, an exemplary information display folder is used to provide an individual or organization with a way to both display information and provide information that can be taken by another party. The information display folder further functions to protect the information from being damaged or destroyed by environmental effects. The information display folder is secured in such a way that it can be easily removed by the owner, yet can still be secured against theft or unauthorized removal by others.

As an example, the information display folder could be used as a way to sell an automobile. The folder can be located over the top edge of a window of the automobile before it is closed or rolled up. When the window is in the up position, the information display folder is secured into place on the outside of the car where the information it contains can be viewed by others. The folder itself is safe from unwanted removal as it is locked into the window and can only be removed by someone who can lower the window. In a similar manner, the folder could also be located over the door of the automobile and locked into place when the door is shut.

The use of the information display folder need not be limited to the sale of the item to which it is attached. As another example of use, the information display folder can be used for the distribution of a variety of information. For instance, the folder can be used to distribute information regarding a lost pet or missing person. Similarly, the information display folder could be used to distribute local and community information regarding up coming events or town meetings. The information display folder can also function in much the same way a classified advertisement works. An individual wishing to sell an item, rent an apartment or even meet people can make their information available to anyone passing by their car or other suitable window. Since the information can move with the car and be posted where ever the car is located, the audience will not be limited to those individuals who see the ad in a periodical, on a website or posted upon a bulletin board. The information display folder can work in conjunction with other means of advertising by making reference to where the particular ad may be found, either on-line or in print.

In one embodiment, the information display folder has a holder with multiple sheets of information about the vehicle that is being advertised for sale. An individual who might be interested in purchasing the car would then be able to remove a page from the folder that contains information about the car and take it with them for further consideration. Together with information about the vehicle, the information page could also contain contact information for the seller of the vehicle. The seller of a car therefore has the ability to provide a large amount of information to a potential buyer without the buyer having to remember the information or copy it on location.

Unlike current automotive display signs, the information display folder does not need to re-apply adhesive or tape each time the folder is removed and repositioned in place. As such, the information display folder is less likely to be left in place by an operator of the vehicle and will therefore not create a driving hazard when the automobile is in use. Because the information display folder can be quickly and easily positioned in place, it can be used whenever the car is parked or left in a location that others may see the vehicle.

An exemplary embodiment of the information display folder is able to protect the enclosed information from most environmental effects yet allows an individual to remove information from the folder easily and quickly. The information display folder can be used year round and in most weather conditions while protecting the enclosed information from damage or destruction.

Besides its use for advertising the sale of an automobile, the information display sign can also be used to sell a house, help locate a lost pet or distribute community information. Using the folder, information can be distributed from any place where a car may be located. Multiple folders can be used on a single vehicle and multiple vehicles can utilize information display folders carrying related or identical information.

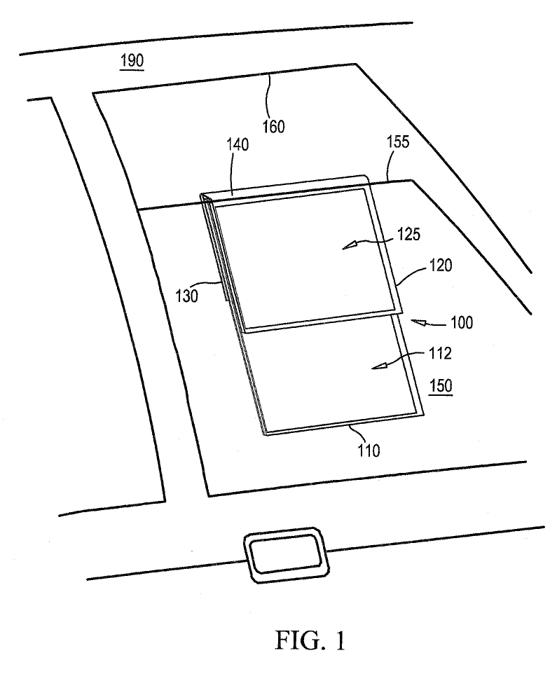

FIGS. 1-4 illustrates one embodiment of an information display folder 100.

FIG. 1 shows the embodiment of the information display folder 100 as it could be positioned on an automobile 190. The folder is comprised of an information pocket 110, an information pocket opening 215, a display pocket 120, a display pocket opening 220, a securing flap 130 and a pliable hinge 140. The information display folder 100 is positioned on a window 150 of an automobile 190 such that the pliable hinge 140 is positioned over the top edge 155 of the automobile's window 150. As the window 150 is rolled up or closed, the pliable hinge 140 is engaged between the top edge 155 and the upper window seal 160 to secure the information display folder 100 to the automobile 190. The pliable hinge 140 can be made to be both thin and flexible enough to fit into the upper window seal 160 without impeding the function of the window 150 or the protective seal created when the top edge 155 is engaged into the upper window seal 160. Once the information display folder 100 is engaged in the window 150, it is secure against theft or unauthorized removal from the automobile 190 as it is temporarily locked into the upper window seal 160 by the top edge 155 of the window 150.

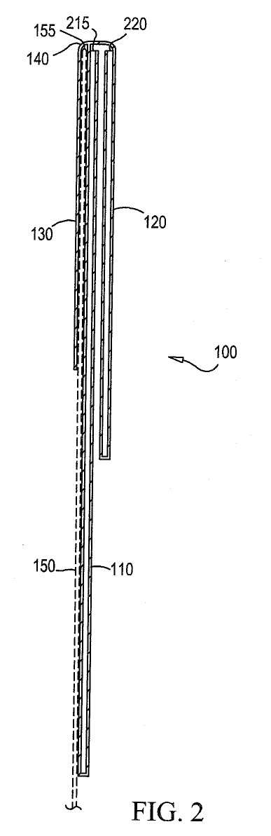

FIG. 2 is a side view of the embodiment showing the relative positioning and size of the component parts. The window 150 is shown positioned between the securing flap 130 and the information pocket 110 wherein the top edge 155 of the window 150 contacts the underside of the pliable hinge 140. Display pocket 120 lies on the outside of the information pocket 110 relative to the window 150. Both the information pocket opening 215 and the display pocket opening 220 are shown located on the sides of the information pocket 110 and display pocket 120 where such sides are in contact. The top portion of the display pocket 120 can then cover the information pocket opening 215 and the display pocket opening 220 from above.

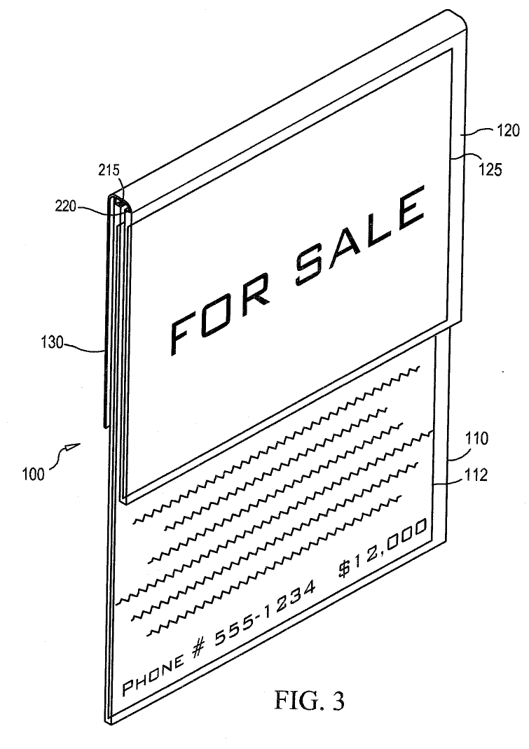

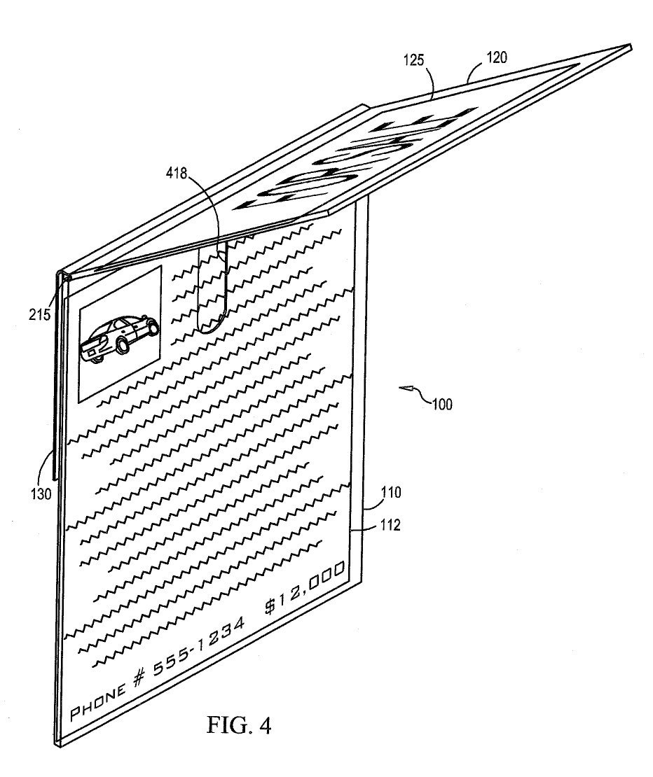

FIGS. 3 and 4 illustrate an embodiment with a display sign 125 in the display pocket 120 and information sheet 112 enclosed within the information pocket 110. The information sheet 112 can be placed within the information pocket 110 via the information pocket opening 215. The display sign 125 can be located within the display pocket 120 via the display pocket opening 220. The thickness and depth of the information pocket 110 and the display pocket 120 can vary depending upon the size or number of information sheets 112 or the size or number of display signs 125. As shown in FIG. 4, an information sheet 112 may be removed by lifting up on the display pocket 120 to expose the information pocket opening 215 and gain access to the information sheet 112. Information pocket opening 215 includes a cut out 418 to make it easier to remove an information sheet 112. Both the information pocket opening 215 and the display pocket opening 220 may be located on the “top” side of the information pocket 110 and display pocket 120 respectively such that when the information display pocket 110 is in the down position, the pliable hinge 140 covers the information pocket opening 215 and the display pocket opening 220. With the display pocket 120 in the down position, as shown in FIG. 2, the information sheet 210 and display sign 125 are covered and may be protected from damage or destruction from environmental effects. In this embodiment, the display pocket 120 is kept in the down or closed position by its own weight. In other embodiments, the display pocket 120 could be kept closed by a securing mechanism such as adhesive, suction cup, hook and loop tape, tab, button, snap, static cling, magnets and the like. Similarly, the information pocket 110 is secured to the window 150 of the automobile 190 by its own weight. In other embodiments, the information pocket 110 can be secured to the window 150 by a securing mechanism such as adhesive, suction cup, static cling or the like.

The embodiment of the information display folder 100 shown in FIGS. 1-4 may be comprised of a clear material (e.g., plastic) such that the information sheet 112 and display sign 125 can be seen through the information pocket 110 and display pocket 120 respectively. In alternative embodiments, other materials may be used in the construction of the information display folder 100 such as glass, metal, vinyl, rubber, coated fabric, fabric and the like. Similarly, in other embodiments, the information pocket 110, display pocket 120 and securing flap 130 could be made from a rigid or non-flexible material that is clear. In yet another embodiment, the information pocket 110, display pocket 120 and securing flap 130 could be made from a rigid or non-flexible material that is also opaque. For example, in some embodiments, the information sheet 112 and the information pocket 110 may be integrated. Similarly, in some embodiments the display sign 125 and the display pocket 120 may be integrated. The information pocket 110 and display pocket 120 could then have a window through which the information sheet 112 and display sign 125 could be seen.

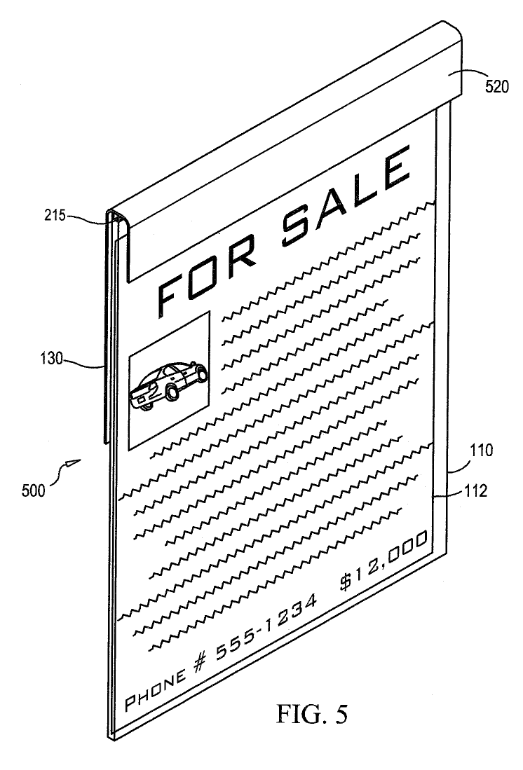

FIG. 5 shows an alternate embodiment of the information display folder 500 wherein the information pocket opening 215 is covered by protective flap 520. The enclosed information page 112 may then contain the display information found on the display sign 220 of the previous embodiment illustrated in FIGS. 1-4. The protective flap 520 could then protect the information page 112 from environmental conditions and, as in previous embodiments, the protective flap 520 could be secured to the information pocket 110 via adhesive, suction cup, hook and loop tape, tab, button, snap, static cling, magnets and the like.

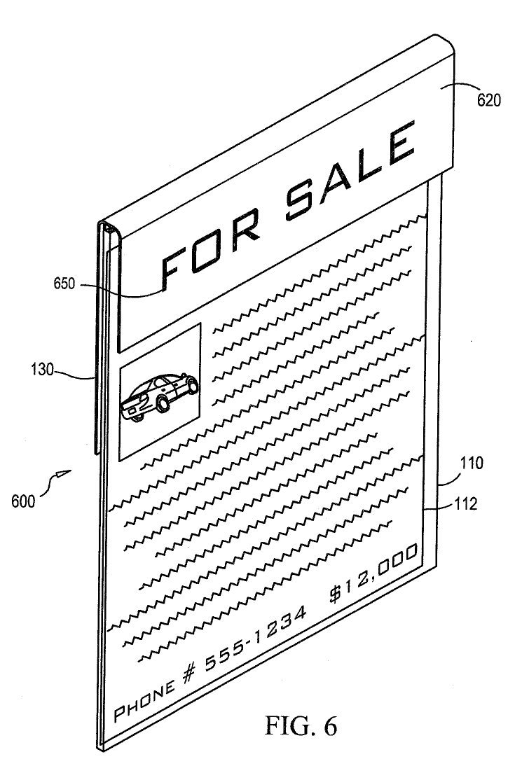

FIG. 6 shows yet another embodiment of the information display folder 600 wherein the display flap 620 displays information 650 on the side of the display flap 620 that is facing away from the automobile. This display information 650 could be affixed directly to the outside of the display flap 620 via printing, embossing, adhering, stamping or the like. The display flap 620 could then protect the information page 112 from environmental conditions and, as in previous embodiments, the display flap 620 could be secured to the information pocket 110 via adhesive, suction cup, hook and loop tape, tab, button, snap, static cling, magnets and the like.

What is claimed is:

1. An information display folder for enclosing and retaining a plurality of documents comprising:
a first panel;
a second panel;
a pocket between said first panel and said second panel having an opening;
said first panel and said second panel joined to said pocket at a spine located at the distal end of said pocket, said spine extending in the direction of the width of said pocket, said opening being located on the side of said pocket adjacent to said first panel; and
wherein said first panel covers said opening of said pocket.

2. The information display folder in claim 1, wherein said first panel is a second pocket.

3. The information display folder in claim 1, wherein said first panel is secured against said pocket by at least one of an adhesive, a suction cup, a hook and loop tape, a tab, a button, a snap, static cling and a magnet.

4. The information display folder in claim 1, wherein said first panel, said second panel and said pocket are comprised of a transparent pliable material with semi-rigid properties.

5. The information display folder in claim 1, wherein said first panel, said second panel and said pocket are comprised of a transparent rigid material.

6. The information display folder in claim 1, wherein said first panel, said second panel and said pocket are comprised of a rigid material.

7. The information display folder in claim 6, wherein said spine is comprised of a pliable material with semi-rigid properties.

8. An information display folder for enclosing and retaining a multiplicity of documents comprising:
a pocket having an opening, a front flap and a back flap, said front flap and said back flap being hingably connected to said pocket at the top end of said pocket, extending in the direction of the width of said pocket wherein said opening is located on the side of said pocket adjacent to said front flap; and
wherein said front flap covers said opening of said pocket.

9. The information display folder in claim 8, wherein said front flap is a second pocket having an opening.

10. The information display folder in claim 8, wherein said front flap is secured against said pocket by a securing means comprising at least one of a group consisting of an adhesive, a suction cup, a hook and loop tape, a tab, a button, a snap, static cling and a magnet.

11. The information display folder in claim 8, wherein said pocket, said front flap and said back flap are comprised of a transparent pliable material with semi-rigid properties.

12. The information display folder in claim 8, wherein said pocket, said front flap and said back flap are comprised of a transparent rigid material.

13. The information display folder in claim 8, wherein said pocket and said front flap are comprised of a rigid material.

14. An information display folder for enclosing and retaining a multiplicity of documents comprising:
a first panel comprising:
a first pocket having a first opening;
a second panel coverably coupled with said first panel to cover said first opening; and
a third panel coupled to the said information display folder to affix said information display folder in a position such that said first pocket is accessible.

15. The information display folder in claim 14, wherein said second panel is comprised of a second pocket having a second opening in a position such that said second panel is coverably coupled with said first panel to cover said second opening.

16. The information display folder in claim 14, wherein said first panel is secured against said first pocket by a securing means comprising at least one of a group consisting of an adhesive, a suction cup, a hook and loop tape, a tab, a button, a snap, static cling and a magnet.

17. The information display folder in claim 14, wherein said first panel, said first pocket, said second panel and said third panel are comprised of a transparent pliable material with semi-rigid properties.

18. The information display folder in claim 14, wherein said first panel, said first pocket, said second panel and said third panel are comprised of a transparent rigid material.

19. The information display folder in claim 14, wherein said first panel, said first pocket, and said second panel are comprised of a rigid material.

20. The information display folder in claim 14, wherein said first pocket is approximately 0.5 to 10 times the length of said first panel and said second panel.
